(19) United States
(12) Patent Application Publication
(10) Pub. No.: US 2025/0177942 A1
(43) Pub. Date: Jun. 5, 2025

(54) APPARATUS AND METHOD FOR CONTROLLING CATALYST TEMPERATURE WITHIN A REACTOR TUBE

(71) Applicant: Air Liquide Large Industries U.S.LP, Houston, TX (US)

(72) Inventor: Gary D. MILLER, Houston, TX (US)

(21) Appl. No.: 18/529,821

(22) Filed: Dec. 5, 2023

(51) Int. Cl. B01J 19/00; C01B 3/38

(52) U.S. Cl. CPC B01J 19/0013; C01B 3/38; B01J 2219/00051; C01B 2203/0233; C01B 2203/1241

(57) ABSTRACT

Method and apparatus for adjusting the temperature inside a reformer tube. Including providing at least one axial quench lance, wherein the at least one axial quench lance configured to receive a temperature control gas, the at least one axial quench lance having multiple delivery holes, and the at least one axial quench lance configured to deliver the temperature control gas through the multiple delivery holes. Inserting the at least one axial quench lance inside the reformer tube, wherein the at least one axial quench lance is located approximately at the axial center of the reformer tube. Filling the reformer tube with catalyst, thereby maintaining the location of the at least one axial quench lance. Introducing the temperature control gas into the at least one axial quench lance, the temperature control gas thereby exiting the multiple delivery holes and entering the catalyst. Adjusting the flow rate of the temperature control gas thereby controlling the temperature of the catalyst.

### BACKGROUND

During normal operation of a tube-type reformer (such as a steam methane reformer), a portion of one or more catalyst tubes may experience unexpectedly higher (or lower) local temperatures. Therefore, typically the overall burner power has to be reduced, or increased, and/or the steam to carbon ratio has to be increased or reduced to control temperature. However, these methods globally affect overall plant efficiency. Therefore, there is a need in the industry for a method for better controlling the temperature in individual Steam Methane Reformer (SMR) tubes.

### SUMMARY

A method and apparatus for adjusting the temperature inside a reformer tube. Including providing at least one axial quench lance, wherein the at least one axial quench lance configured to receive a temperature control gas, the at least one axial quench lance having multiple delivery holes, and the at least one axial quench lance configured to deliver the temperature control gas through the multiple delivery holes. Inserting the at least one axial quench lance inside the reformer tube, wherein the at least one axial quench lance is located approximately at the axial center of the reformer tube. Filling the reformer tube with catalyst, thereby maintaining the location of the at least one axial quench lance. Introducing the temperature control gas into the at least one axial quench lance, the temperature control gas thereby exiting the multiple delivery holes and entering the catalyst. Adjusting the flow rate of the temperature control gas thereby controlling the temperature of the catalyst.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1a is a schematic representation of a view of an axial quench lance with delivery holes equally spaced along the length, in accordance with one embodiment of the present invention.

FIG. 1b is a schematic representation of a view of an axial quench lance with delivery holes spacing varying along the length, in accordance with one embodiment of the present invention.

FIG. 2 is a schematic representation of a cross-sectional view of a reactor tube, an axial quench lance, and a centering ring, in accordance with one embodiment of the present invention.

FIG. 3 is a schematic representation of a cross-sectional view of a reactor tube, two axial quench lances, and a centering ring, in accordance with one embodiment of the present invention.

FIG. 4 is a schematic representation of an isometric view of the axial quench lance and centering ring located in a reactor tube, in accordance with one embodiment of the present invention.

FIG. 5 is a schematic representation of an isometric view of the axial quench lance and centering ring located in a reactor tube that is partially filled with catalyst, in accordance with one embodiment of the present invention.

### ELEMENT NUMBERS

101=steam methane reformer tube
103=centering ring
105=catalyst
106=axial quench lance
106a=first axial quench lance
106b=second axial quench lance
113=bottom (distal end) of the reactor tube
114=top (proximal end) of the reactor tube
124=gas entering the axial quench lance
125a-f=gas exiting the axial quench lance
126=bottom (distal end) of the axial quench lance
127=top (proximal end) of the axial quench lance
128=delivery hole

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Details of the design and operation of the reactor tube filling, at least, are as described in U.S. Pat. Nos. 11,253,830; 11,517,867; 11,534,731; and 11,541,366; the relevant part which is incorporated herein by reference.

As an overview, an apparatus and method is provided for inserting and utilizing an axial quench lance is provided. A centering ring is centered within an empty reformer tube. Then using a method or apparatus in the incorporated references, the reformer tube is filled with catalyst and the axial quench lance is approximately centered in the reformer tube and held in place by the catalyst.

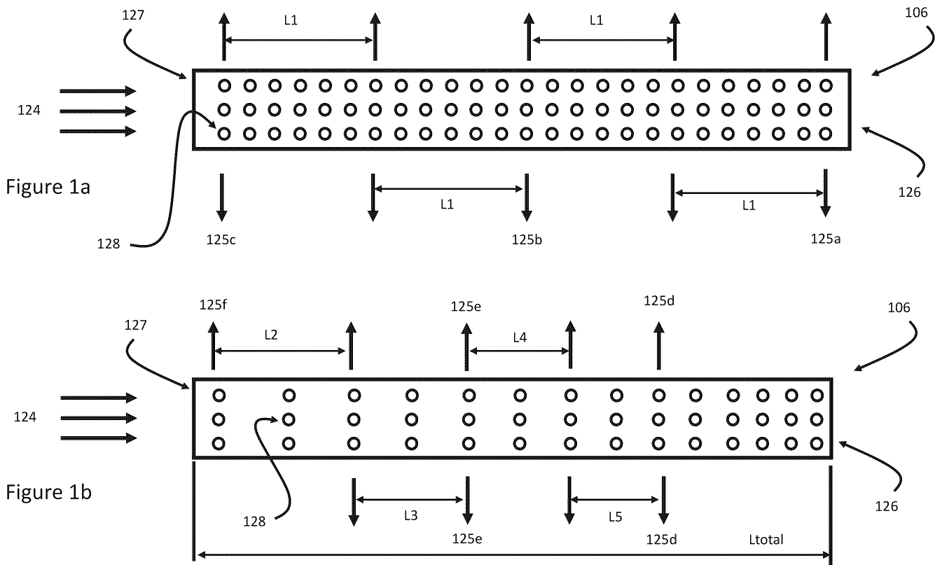

FIG. 1a and FIG. 1b represent a side-view of axial quench lance 106. FIG. 1a illustrates the embodiment wherein the delivery holes 128 are approximately equally spaced around the circumference C and along the total length Ltot of the lance. Thus, along the length of the lance, spacing L1 remains constant. FIG. 1b illustrates the embodiment wherein the delivery holes spacing varies along the length of the lance. Thus, along the length of the lance, spacing L2>L3>L4>L5. The skilled artisan would determine the diameter of delivery holes 128, the number of delivery holes 128 along the length of axial quench lance 106, and the relative spacing circumferentially as well as along the length of axial quench lance 106, for optimum flow considering the specific design considerations.

Gas 124 enters axial quench lance 106 through proximal end 127. As gas 124 flows through axial quench lance 106, along the entire length portions of this gas will exit axial quench lance 106 and enter the inside of reactor tube 101. Axial quench lance 106 may have holes approximately equally spaced as shown in FIG. 1a, thus allowing a percentage 125a of gas 124 to pass through the entire length of axial quench lance 106 and exit near distil end 126. A percentage 125b of gas 124 will exit further from distil end 126, as indicated at approximately the middle of the axial quench lance 106 length. And a percentage 125c of gas 124 will exit near proximal end 127. If desired, the distribution of gas 124 exiting axial quench lance 106 may be modified by varying the location of the holes along the length, as shown in FIG. 1b.

Gas 124 may be reformer tube inlet gas, which comprises the relatively cold mixed feed gas that is entering the reformer tube itself. Utilizing reformer tube inlet gas and controlling the flowrate will allow the user to reduce the bulk temperature of the SMR reactor tube 101 along the entire length. Gas 124 may be reformer tube outlet gas, which comprises the relatively hot syngas that is exiting the reformer tube itself. Utilizing reformer tube outlet gas and controlling the flowrate will allow the user to increase the bulk temperature of the SMR reactor tube 101 along the length. In another embodiment, two axial quench lances 106a/106b may be inserted into reactor tube 101. Axial quench lance 106a, for example, may be designed to flow the relatively cold mixed feed gas, and axial quench lance 106b may be designed to flow the relatively hot syngas exiting the reformer tube. This arrangement will allow the user to control the bulk temperature by either heating or cooling catalyst 105 and/or reactor tube 101 as required.

The skilled artisan will recognize the value in the above ability to control internal tube temperature. In the current state-of-the-art each reformer tube is functionally operated as a plug flow reactor. The reactor tube internal temperature cannot be controlled, except in a very gross way by modulating the temperature of the entire furnace. The present invention effectively turns each reactor tube into a quench style reactor. In addition to the above-described temperature control, the current method improves mixing, thus improving mass and heat transfer within the tube. One skilled in the art will recognize that the above will effectively tailor the reaction. This scheme also effectively allows the furnace to run at a given conversion but at a cooler temperature, thereby potentially extending equipment life.

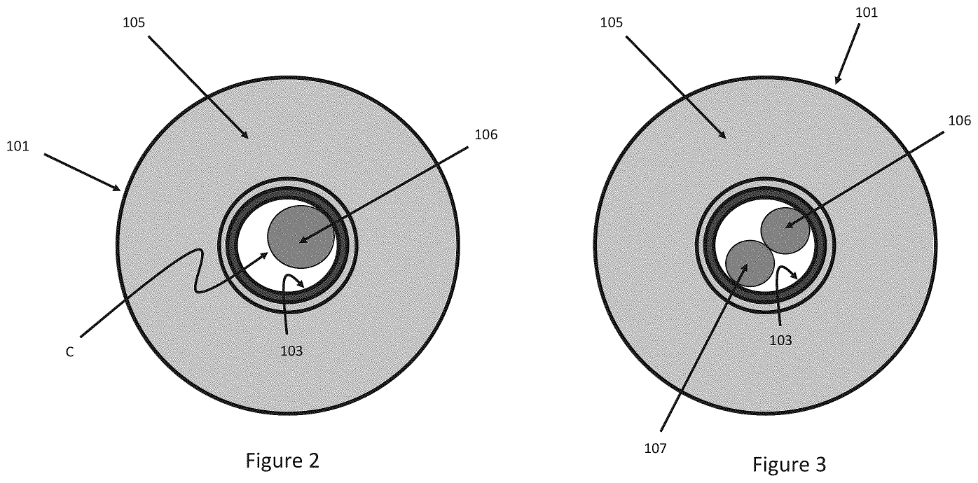

FIG. 2 and FIG. 3 represent a cross-sectional view of reactor tube 101 utilizing the instant apparatus and method. Reactor tube 101 may be a steam methane reformer (SMR) tube, filled with catalyst 105, and containing centering ring 103. Within centering ring 103 is at least one axial quench lance 106. Axial quench lance 106 is located inside of centering ring 103, and after installation is also positioned near the axial center of reactor tube 101. In another embodiment, as illustrated in FIG. 3, two axial quench lances 106a and 106b are presented. As discussed above, this allows the operator to either heat or cool the tube temperature as required.

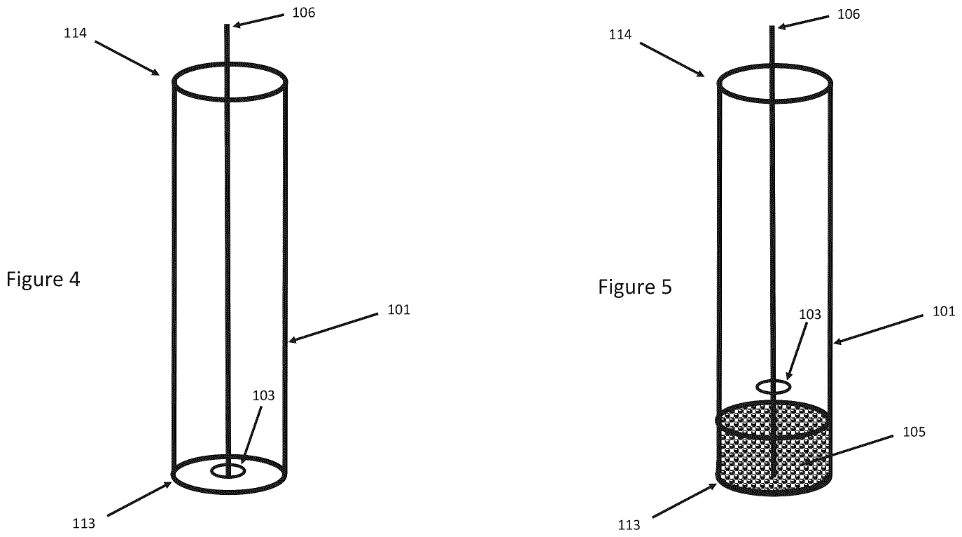

FIG. 4 and FIG. 5 represent the basic installation method for axial quench lance 106. Starting at proximal end 114, axial quench lance 106 is then inserted down the length of empty reactor tube 101, until it is near distil end 113. As reactor tube 101 is filled with catalyst 105, as described in the incorporated patents, centering ring 103 is raised, keeping axial quench lance 106 approximately centered in reactor tube 101.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A device for adjusting the temperature inside a reformer tube, comprising:
at least one axial quench lance,
wherein the at least one axial quench lance is configured to receive a temperature control gas,
wherein the at least one axial quench lance comprises multiple delivery holes, and
wherein the at least one axial quench lance is configured to deliver the temperature control gas through the multiple delivery holes,
the at least one axial quench lance is located inside the reformer tube, wherein the at least one axial quench lance is located approximately at the axial center of the reformer tube, and
the reformer tube is filled with catalyst, thereby maintaining the location of the at least one axial quench lance.

2. The device of claim 1, wherein the at least one axial quench lance comprises a lance length and a lance circumference,
wherein the multiple delivery holes are equally spaced along the lance length, and
wherein the multiple delivery holes are equally space around the lance circumference.

3. The device of claim 1, comprising a single axial quench lance.

4. The device of claim 1, comprising two axial quench lances.

5. A method for adjusting the temperature inside a reformer tube, comprising:
providing at least one axial quench lance,
the at least one axial quench lance configured to receive a temperature control gas,
the at least one axial quench lance comprising multiple delivery holes, and
the at least one axial quench lance configured to deliver the temperature control gas through the multiple delivery holes,
inserting the at least one axial quench lance inside the reformer tube, wherein the at least one axial quench lance is located approximately at the axial center of the reformer tube, and
filling the reformer tube with catalyst, thereby maintaining the location of the at least one axial quench lance,
introducing the temperature control gas into the at least one axial quench lance, the temperature control gas thereby exiting the multiple delivery holes, and entering the catalyst,
adjusting the flow rate of the temperature control gas thereby controlling the temperature of the catalyst.

6. The method of claim 5, wherein the at least one axial quench lance comprises a lance length and a lance circumference,
wherein the multiple delivery holes are equally spaced along the lance length, and
wherein the multiple delivery holes are equally space around the lance circumference.

7. The method of claim 5, comprising a single axial quench lance.

8. The method of claim 5, wherein the temperature control gas is reformer tube outlet gas.

9. The method of claim 5, wherein the temperature control gas is reformer tube inlet gas.

10. The method of claim 5, comprising a first axial quench lance and a second axial quench lance.

11. The method of claim 10, wherein the temperature control gas entering the first axial quench lance is reformer tube inlet gas, and
wherein the temperature control gas entering the second axial quench lance is reformer tube outlet gas.
